(19) United States
(12) Patent Application Publication
(10) Pub. No.: US 2019/0350253 A1
(43) Pub. Date: Nov. 21, 2019

(54) HEAT MANAGEMENT ACCESSORY FOR HOOKAH

(71) Applicant: Kaloud, Inc., Los Angeles, CA (US)

(72) Inventors: Reza Bavar, Los Angeles, CA (US); Skyler Olsen, Denver, CO (US)

(21) Appl. No.: 16/529,258

(22) Filed: Aug. 1, 2019

Related U.S. Application Data
(63) Continuation-in-part of application No. 14/948,186, filed on Nov. 20, 2015, now Pat. No. 10,383,363.
Application No. 14/948,186 is a continuation-in-part of application No. PCT/US14/66709, filed on Nov. 20, 2014.

(51) Int. Cl. A24F 1/30; A24F 5/08; A24F 5/10; H05B 3/06

(52) U.S. Cl. CPC A24F 1/30; A24F 5/08; H05B 2203/035; H05B 3/06; A24F 5/10

(57) ABSTRACT

A heat management system, device, and method are provided for a system for facilitating smoking of tobacco from a hookah having a bowl with an interior space for holding organic matter to be smoked by a user. An electric heating head is provided for resting on the bowl, the electric heating head having a heating element, a screen located between the heating element and the bowl when the heating head is rested on the bowl, and a lower air gap between the heating element and the screen.

### CROSS REFERENCE TO RELATED APPLICATIONS

This application is a Continuation in Part of U.S. application Ser. No. 14/948,186, filed Nov. 20, 2015, which is a continuation-in-part of PCT/US2014/066709, filed Nov. 20, 2014 which are hereby incorporated by reference in their entirety.

The present application is related to U.S. application Ser. No. 13/489,475, filed Jun. 6, 2012; U.S. application Ser. No. 14/549,435, filed Nov. 20, 2014; and U.S. application Ser. No. 14/948,168, filed Nov. 20, 2015, each of which are incorporated herein by reference in their entirety.

### BACKGROUND OF THE INVENTION

The subject matter described herein relates generally to systems, devices, and methods for managing heat in preparing tobacco or other organic material for smoking using a water pipe, such as a hookah. Traditional water pipes generally include a plate for supporting charcoal, a head for containing tobacco, a body including an internal pipe, a base for containing water, and a hose. Typically a user will first fill the base with water and then place the internal pipe into the water such that the body creates an airtight seal with the base. The head is then filled with tobacco or other organic material and placed over the internal pipe such that an airtight seal is created between the internal pipe and the head. Next the user places the plate over the head, places one or more lit charcoals on the plate and these charcoals serve to heat the tobacco underneath the plate. The hose is typically attached to the body such that it has an airtight connection with air above the water in the base. The user can inhale through the hose which draws smoke from the heated tobacco in the head through the internal pipe, through the water contained in the base, through the hose and into the user's lungs.

In some embodiments, a user may wish to substitute an electrical heating element in place of the charcoal. However, existing electrical heating elements are inadequate for use with hookahs.

The embodiments provided herein teach features and advantages heretofore untaught by the prior art, as will be clear to one of ordinary skill in the art.

### SUMMARY OF THE INVENTION

Briefly and in general terms, the embodiments described herein provide for a system, method and device for smoking tobacco (or other organic matter) via a water pipe.

These and other aspects and advantages of the instant invention will be apparent from the following detailed description and the accompanying drawing, which illustrates by way of example the principles and features of the instant invention.

In one embodiment, an electrical heating head is provided for resting on a bowl operable to contain tobacco or other smokable substances, the heating head comprising a heating element, a screen located between the heating element and the bowl when the heating head is rested on the bowl, and a lower air gap between the heating element and the screen. The screen is finer than the smokable organic substance, so that the substance does not pass through the screen.

The heating head may include ridges for coupling with the bowl. In such an embodiment, the heating head can be fixedly coupled with the bowl when resting on the bowl. Other fixation structures may be used as well.

In some embodiments, the heating head may include nodules on a bottom surface of the screen.

In some embodiments, the heating element is perforated such that air passes through the heating element and through the screen into the bowl. Typically, the only path between an interior space of the heating head and the bowl is through the heating element.

A printed circuit board (PCB) may be provided and located adjacent an outer wall of the heating head, and the heating element may be centered in the heating head. In some embodiments, the PCB may form a circumferential ring surrounding the heating element. The heating head may further comprise a heat shield insulating the PCB from the heating element.

In some embodiments, vents may be provided adjacent the PCB for cooling the PCB.

The heating head may further comprise a ventilated housing and a battery, and the heating element, screen, and battery are then all located within the housing. The battery may be opposite the heating element from the screen, such that the heating element is between the battery and the screen. An upper air gap then may be provided between the heating element and the battery and a lower air gap is provided between the heating element and the screen.

Venting openings are then provided in the housing, such that environmental air passes through the venting openings into the upper air gap. Air in the upper air gap then is heated by the heating element as it passes through the perforations into the lower air gap. Air then passes through the screen into the bowl.

Perforations in the heating element are typically larger than perforations in the screen, and additional heat shields may be provided, such as a heat shield for insulating the battery from the rest of the interior space.

### BRIEF DESCRIPTION OF THE SEVERAL VIEWS OF THE DRAWING(S)

Illustrated in the accompanying drawing(s) is at least one of the best mode embodiments of the present invention. In such drawing(s):

FIG. 1A illustrates an example embodiment of a water pipe in accordance with the present invention.

FIG. 1B shows a schematic view of an example embodiment of a water pipe in accordance with the present invention

FIG. 2A shows a side view of the example embodiment of a bowl in accordance with the present invention.

FIG. 2B shows a cutaway view of the example embodiment of a bowl in accordance with the present invention.

FIG. 3A shows a perspective view of an example embodiment of a ventilated cover platform in accordance with the present invention.

FIG. 3B shows a perspective view of an example embodiment of a ventilated cover platform in accordance with the present invention.

FIG. 3C shows a cutaway side view of an example embodiment of a ventilated cover platform in accordance with the present invention.

FIG. 3D shows a side view of an example embodiment of a ventilated cover platform in accordance with the present invention.

FIG. 3E shows a top view of an example embodiment of a ventilated cover platform in accordance with the present invention.

FIG. 4A shows a perspective view of the example embodiment of a ventilated cover cap on a bowl in accordance with the present invention.

FIG. 4B shows a perspective view of the example embodiment of a ventilated cover cap in accordance with the present invention.

FIG. 4C shows a side view of the example embodiment of a ventilated cover cap in accordance with the present invention.

FIG. 4D shows a top view of the example embodiment of a ventilated cover cap in accordance with the present invention.

FIG. 4E shows a cutaway side view of the example embodiment of a ventilated cover cap in accordance with the present invention.

FIG. 5A shows a cross sectional view of the example embodiment of a coupled ventilated cover cap, platform and head including airflow in accordance with the present invention.

FIG. 5B shows a close-up cross sectional view of the example embodiment of a coupled ventilated cover cap, platform and head in accordance with the present invention.

FIG. 5C shows a side view of the example embodiment of a coupled ventilated cover cap, platform and head in accordance with the invention.

FIG. 5D shows a side view of the example embodiment of a coupled ventilated cover cap, platform and head in accordance with the invention.

FIG. 5E shows a perspective view of the example embodiment of a coupled ventilated cover cap, platform and head in accordance with the invention.

FIG. 5F shows a perspective view of the example embodiment of a coupled ventilated cover platform and head with decoupled ventilated cover cap in accordance with the invention.

FIG. 5G shows a side view of the example embodiment of a decoupled ventilated cover cap and platform according the invention.

FIG. 6A shows a top perspective view of an example embodiment of a ventilated cover with closed cover vents in accordance with the present invention.

FIG. 6B shows a top perspective view of an example embodiment of a ventilated cover with partially closed cover vents in accordance with the present invention.

FIG. 6C shows a top perspective view of a ventilated cover with open cover vents in accordance with at least one embodiment of the present invention.

FIG. 6D shows a top perspective view of an example embodiment of a ventilated cover with top removed in accordance with the present invention.

FIG. 6E shows an example embodiment of a bottom perspective view of a ventilated cover in accordance with the present invention.

FIG. 7A-7E show an example embodiment of a use case of a ventilated cover in accordance with the present invention.

FIG. 8A shows an example embodiment of a perspective view of a ventilated cover cap and multi-functional tongs in accordance with the present invention.

FIG. 8B shows an example embodiment of a perspective view of multi-functional tongs in accordance with the present invention.

FIG. 8C shows an example embodiment of a side view of a ventilated cover and coupled bowl with multi-functional tongs in a use case in accordance with the present invention.

FIG. 9A shows an example embodiment of a top perspective view of a ventilated cover cap in accordance with the present invention.

FIG. 9B shows an example embodiment of a bottom perspective view of a ventilated cover cap in accordance with the present invention.

FIG. 10 shows an example embodiment of a top perspective view of a ventilated cover platform in accordance with the present invention.

FIG. 11A shows a side cutaway view of an example embodiment of a coupled ventilated cover cap, platform and head in a closed configuration in accordance with the present invention.

FIG. 11B shows a side cutaway view of an example embodiment of a coupled ventilated cover cap, platform and head in an open configuration in accordance with the present invention.

FIG. 11C shows an example embodiment of a ventilated cap coupled to a bowl.

FIG. 12A shows a cross sectional view of a heating head in accordance with the present invention resting on a bowl.

FIG. 12B shows a cross sectional perspective view of the heating head shown in FIG. 12A.

FIG. 12C shows a cross sectional perspective view of the heating head shown in FIG. 12A showing airflow through the heating head during use.

FIG. 12D shows an enlarged view of an edge of the heating head shown in FIG. 12A resting on a bowl.

FIG. 12E shows a side view and FIGS. 12F and 12G show perspective views of the heating head shown in FIG. 12A resting on a bowl.

FIGS. 12H and 12I show perspective views of the heating head of FIG. 12A separated from a bowl.

### DETAILED DESCRIPTION OF THE PREFERRED EMBODIMENTS

The above described drawing figures illustrate the described invention and method of use in at least one of its preferred, best mode embodiment, which is further defined in detail in the following description. Those having ordinary skill in the art may be able to make alterations and modifications to what is described herein without departing from its spirit and scope. While this invention is susceptible of embodiment in many different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

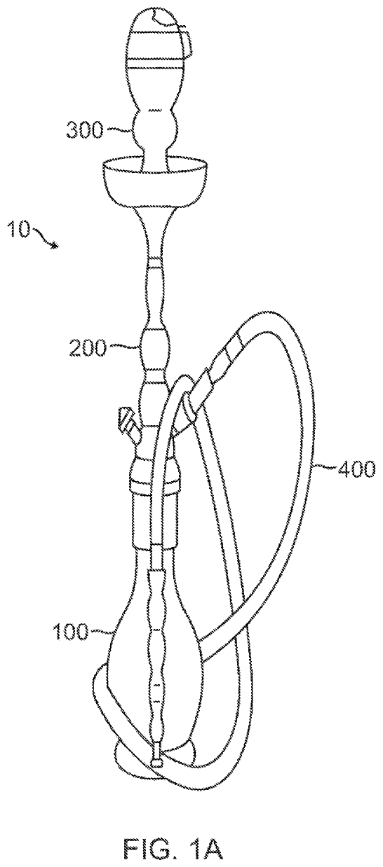

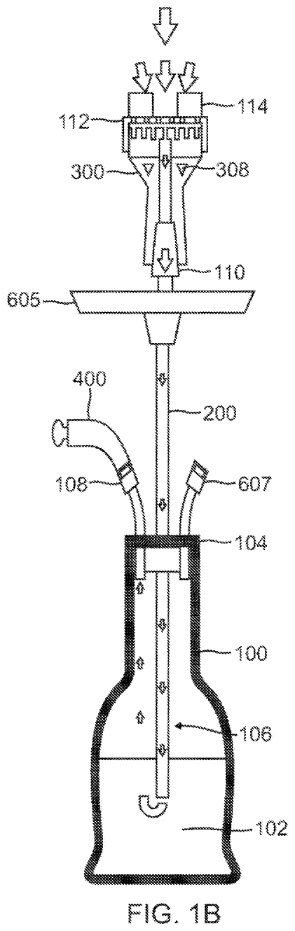

FIG. 1 illustrates an exemplary water pipe 10 in accordance with at least one embodiment of the present invention. As shown in FIG. 1A, the water pipe generally comprises: a base 100, a stem 200, a bowl 300, and a hose 400. An exemplary water pipe is described in U.S. patent application Ser. No. 13/489,475, filed on Jun. 6, 2012, the entire contents and disclosure of which is herein incorporated by reference.

As shown for example in FIG. 1B, in general, the base 100 comprises a concave vessel having an open top portion for containing water or other liquid 102 therein. The stem 200 extends into the base such that a distal end of the stem is partially submerged within the liquid 102 contained therein. The stem 200 also couples to the open top portion of the base so as to form a substantially airtight seal therewith. Accordingly, a first base grommet 104 may be provided to couple the stem 200 and the base 100 so as to form the substantially airtight seal. In this manner, a chamber is formed by the base 100 and stem 200/grommet 104. The hose 400 extends into the base 100 such that a proximal portion of the hose 400 is in fluid communication with the chamber 106, though preferably not within the contained liquid 102 (e.g. air can pass between chamber 106 and hose 400). Preferably, a substantially airtight seal is formed from the coupling of the hose 400 and base 100. Accordingly, a second hose grommet 108 may be provided to couple the hose 400 and the base 100 so as to form the substantially airtight seal. In some embodiments, a hose valve (not shown) may be intermediate the hose 400 and the base 100, the hose valve extending into the chamber 106 at one end and exterior to the chamber 106, coupling with the hose 400, at the other. Bowl 300 couples to a proximal end of stem 200 such that a substantially airtight seal is formed therebetween. Accordingly, a third bowl grommet 110 may be provided to couple bowl 300 and stem 200 so as to form the substantially airtight seal. In operation, organic matter to be smoked 308 may be contained within bowl 300, and bowl 300 may be covered with a cover 112, such as punctured foil, or a ventilated cover such as that described in U.S. patent application Ser. No. 13/489,475, filed on Jun. 6, 2012, the entire contents and disclosure of which is herein incorporated by reference. Coals 114 or other combustible heating material can be placed on or in cover 112 to heat the tobacco 308.

Critically, bowl 300, stem 200 and hose 400 each comprise a hollow tube such that when base 100, bowl 300, stem 200 and hose 400 are coupled, an airflow path is formed. As illustrated in FIG. 1B, a user inhaling at the distal end of hose 400 may thus draw heated air into bowl 300, causing the organic material 308 therein to burn, releasing smoke that is subsequently drawn through bowl 300, through stem 200, and into liquid 102 contained within chamber 106 of base 100. The smoke then rises through liquid 102 into the preferably sealed area above liquid 102 in the chamber 106, becoming filtered in the process, and inhaled through hose 400 as it is smoked by the user.

Other water pipe components, such as purge valves, ashtrays, base flavorings, etc. are generally known in the art and, while not specifically described herein, are intended to be useable in combination with the presently described embodiments without departing from the scope of the invention.

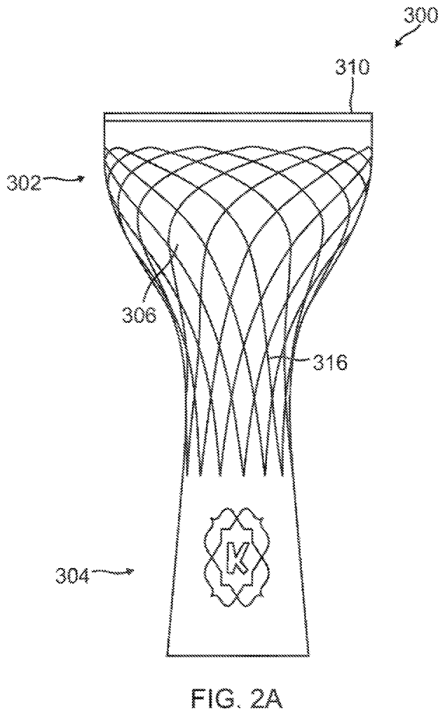

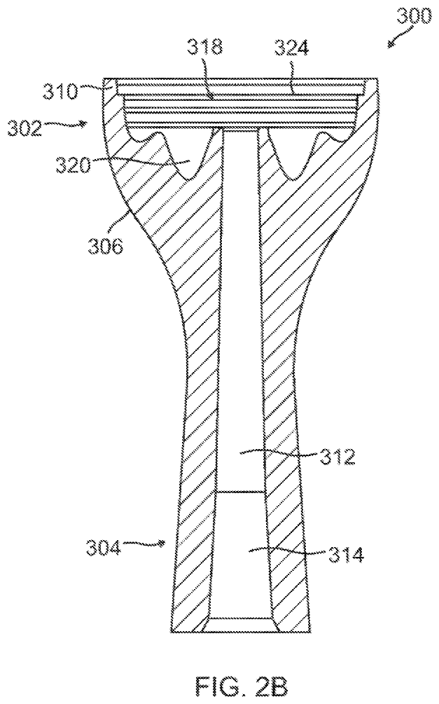

An example embodiment of a bowl 300 in accordance with the present invention will now be described with reference to FIG. 2.

As shown for example in FIGS. 2A-2B, a bowl 300 preferably generally comprises a substantially hemispherical bowl head 302 extending vertically and radially from a substantially cylindrical bowl stalk 304. As shown, bowl stalk 304 may be flared outward at its bottom end to facilitate easier manipulation. The bowl 300 preferably further comprises interior 307 and exterior 306 surfaces separated by a rim portion 310. In some embodiments, located central to the bowl head 302, and forming a portion of the inner surface of the bowl 300, may be a hollow tube 312 extending the length of the bowl 300 from the bowl head 302 through the bowl stalk 304. The hollow tube 312, and other structures herein described, are additionally shown in FIG. 2B, which is a cross-sectional illustration of an example embodiment of a bowl 300.

Bowl head 302 preferably further comprises a plurality of compartments 320 therein for containing the organic matter or other material to be smoked. Accordingly, internal walls 322 may separate adjacent compartments 320. A plurality of internal walls 322 may extend inward from the interior surface of the bowl head to hollow tube 312, forming the plurality of compartments 320. Accordingly, each internal wall 322 may partially or wholly separate adjacent compartments 320. Compartments 320 may have varied dimensions and may be uniform or sized differently in different embodiments. In the example embodiment each compartment is of equal depth and similar dimensions and shape. Each compartment may have a “U” shaped cross sectional profile when viewed from a side. Alternatively, each compartment may have a “V” shape, open-top square shape, open-top rectangular shape or other shapes.

As shown in FIG. 2B, in some embodiments the compartments 320 are slightly recessed from an upper elevation of the rim 310, forming a space 318 between a cover and the organic matter to be smoked so as to promote airflow from the organic matter to the hollow tube 312.

As shown for example in FIG. 2B, the bowl stalk 304 may further comprise a grommet 314 for effecting a substantially airtight seal with a water pipe stem. In some embodiments the grommet 314 may include threading, tread, ribs or other surface characteristics. Grommet 314 may be the same material as the rest of bowl 300 although in some embodiments it may also be a different material. For instance, grommet 314 may be rubber to promote better sealing characteristics. Grommet 314 may be flared as shown in the example embodiment of FIG. 2C by the concentric rings at the center. This may create a conical cross section of grommet 314 when viewed from the side of bowl 300. The conical cross section may promote better sealing characteristics with a water pipe stem and ease of user coupling of head 300 with the water pipe stem. In operation, the grommet 314 can replace a traditional bowl grommet shown in FIG. 1B.

As shown for example in FIG. 2A, an exterior surface of the bowl may comprise a grip portion 316. In some embodiments, this grip portion 316 may include a friction surface providing additional grip to the user. The grip surface may include ridges, bumps, depressions and other features. The grip portion 316 in the example embodiment is a series of lines with arcing features, running generally parallel to each other around bowl 300. A similar series of lines with arcing features in an opposite direction run generally substantially parallel to each other around bowl 300 such that numerous intersections of each set of lines with any one line creates a cross-hatched pattern around bowl 300.

In at least one embodiment, bowl 300 is made of silicone material. Silicone may have advantages such as improved insulation around the head 302 and improved heat distribution inside the head 302 and may also provide improved uniformity of heat distribution. Improved insulation around head 302 may provide an improved user experience since users are less likely to burn themselves when handling bowl 300 when it is hot. Improved heat distribution inside head 302 may provide an improved user experience since it promotes even heating characteristics for organic matter in compartments 320. As such, organic matter may be evenly heated and less likely to have some portions burn while others remain unheated. In other embodiments clay, marble, glass, or other appropriate materials may be used.

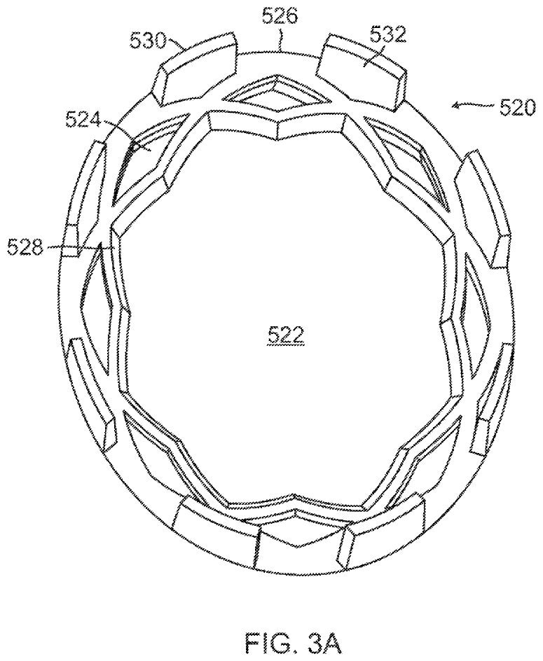

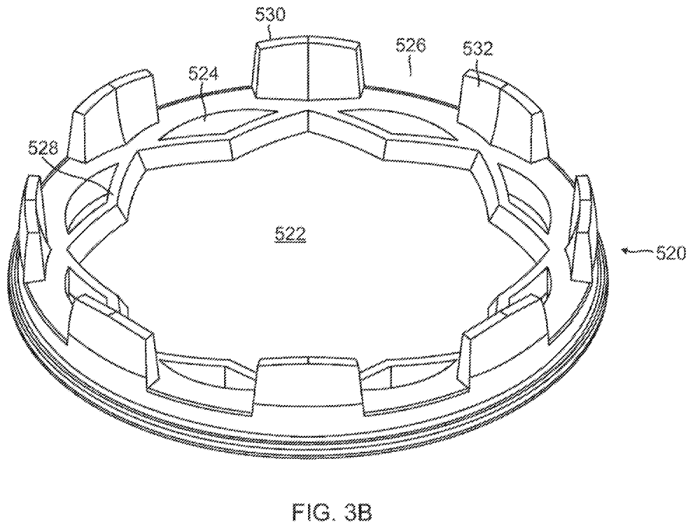

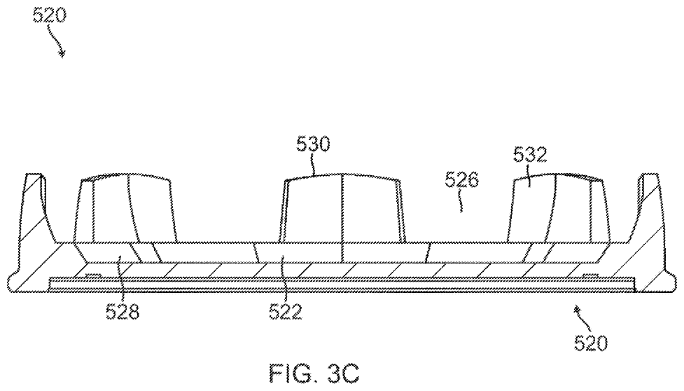

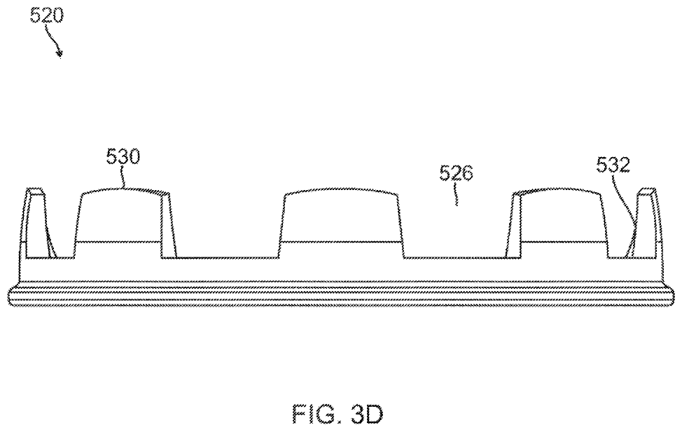

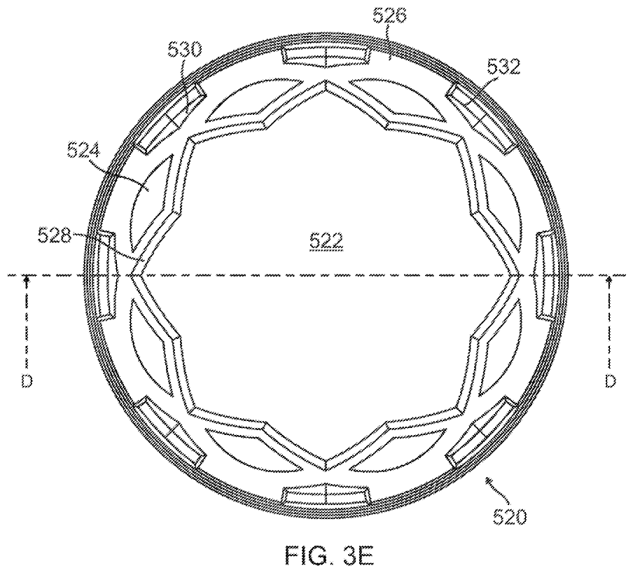

As shown for example in FIG. 2B, the rim portion 310 may further comprise a coupling surface for frictionally coupling a cover (not shown) to the bowl such that charcoal or other heat source may provide heat to the tobacco or other organic substance while remaining separated therefrom, in accordance with the embodiments and concepts discussed herein. This coupling surface can include ridges 324 which can be arranged in a fashion to promote an airtight seal and a screwing type seal. In some embodiments, the cover preferably comprises a ventilated cover, such as the exemplary ventilated cover show for example in FIGS. 3A-6E, as well as the ventilated cover described in U.S. patent application Ser. No. 13/489,475, filed on Jun. 6, 2012. In some embodiments, a coupling surface may be an interior surface of the rim 310. In some embodiments, the coupling surface may be an exterior surface of the rim 310. In some embodiments, the coupling surface may be an upper surface of the rim 310. In some embodiments, the coupling surface may be a combination of more than one of an exterior, interior and upper surface of the rim 310. Preferably, the coupling surface includes tread, threading, ribs or similar structure adapted to increase the frictional coupling of the cover with the bowl 300.

In accordance with the bowl of FIG. 2, a user can insert a metered amount of tobacco, shisha or other organic material into one or more of compartments 320 before or after coupling bowl 300 with a stem of a water pipe in order to prepare the bowl 300 for smoking.

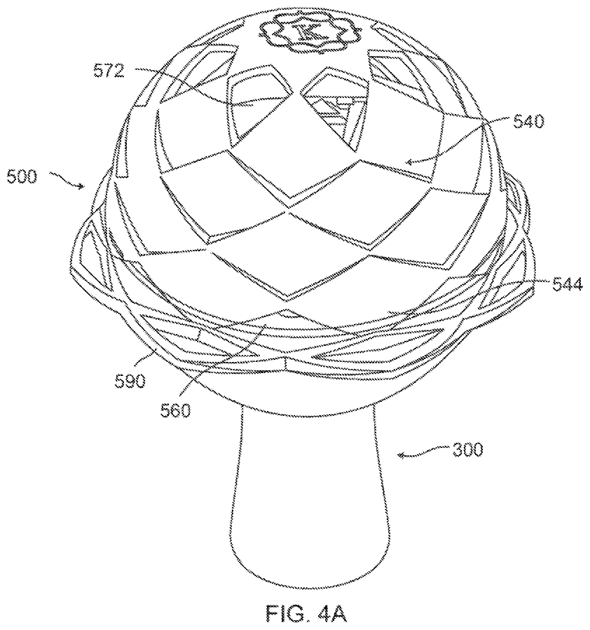

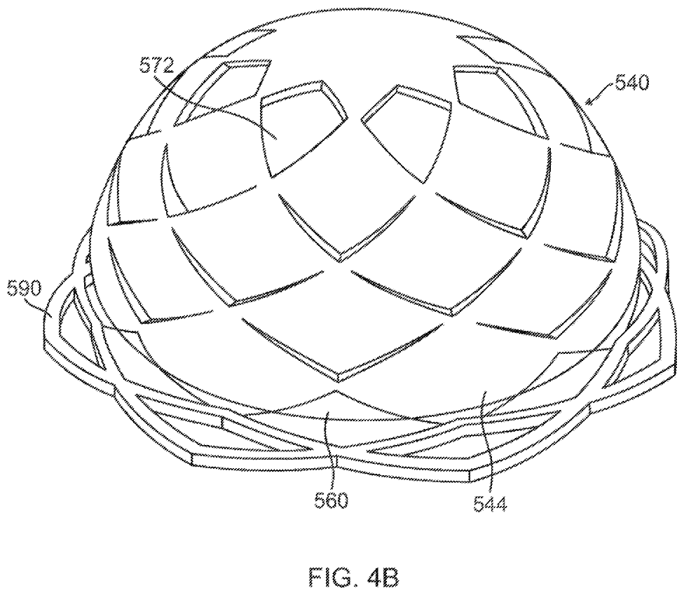

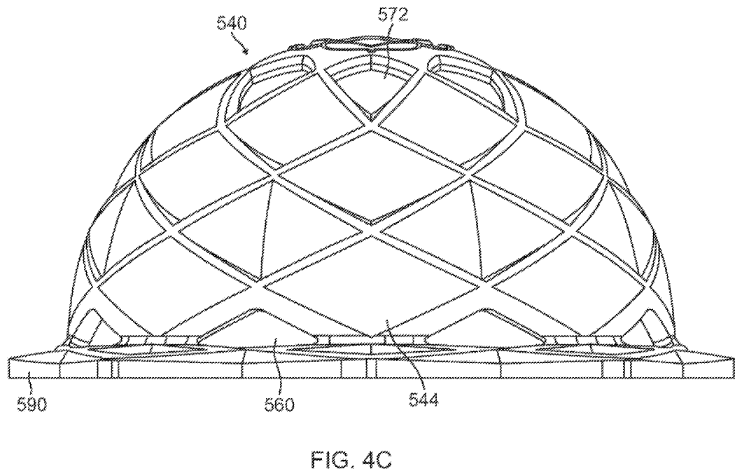

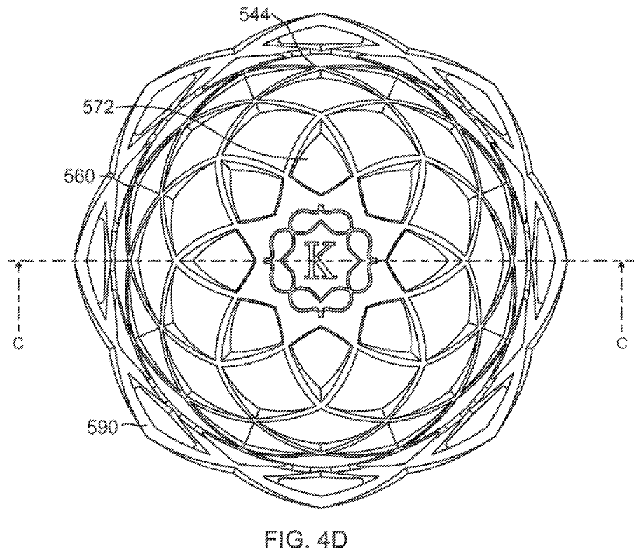

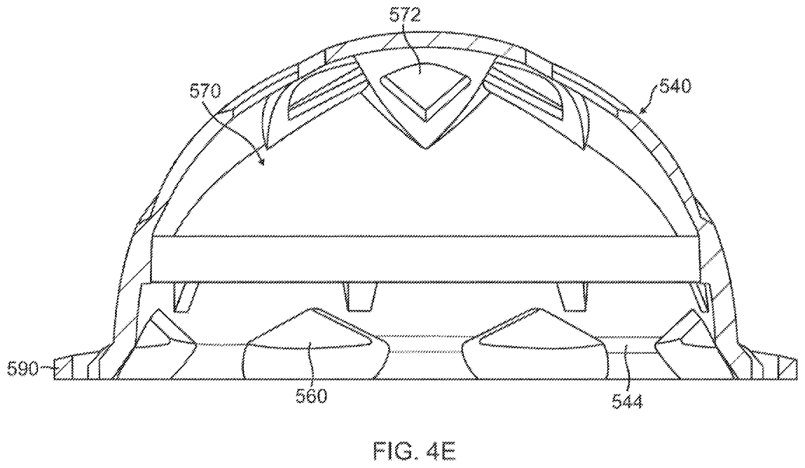

FIGS. 3-4 illustrate an example embodiment of a ventilated cover 500 for use in accordance with at least one embodiment of the present invention. The ventilated cover 500 may include a platform 520 on which to support coal or other heating source as shown in FIG. 3, and a cap 540 resting on or coupled to the platform so as to form a heating chamber 570, as shown in FIG. 4E-4F, 5A-5B. Airflow through cover 500 may be controllable by rotating cap 540 relative to the platform 520.

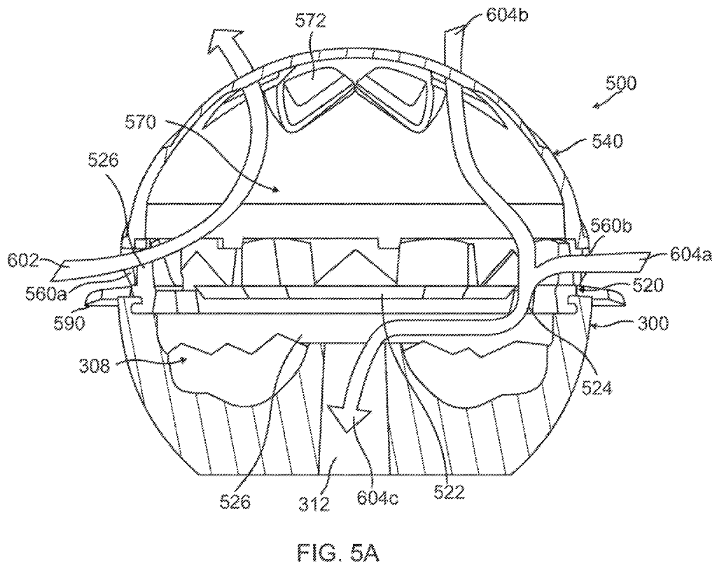

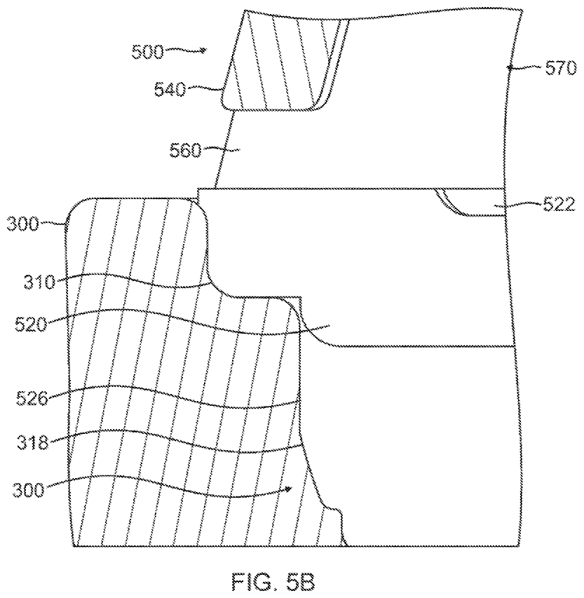

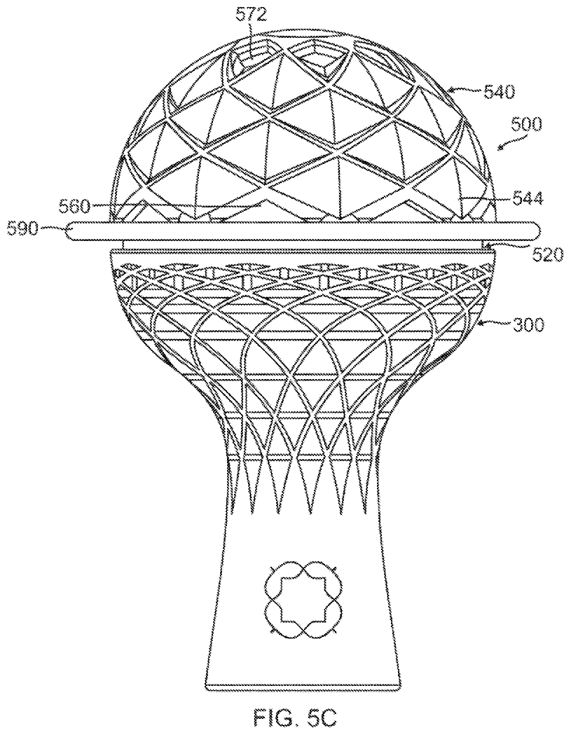

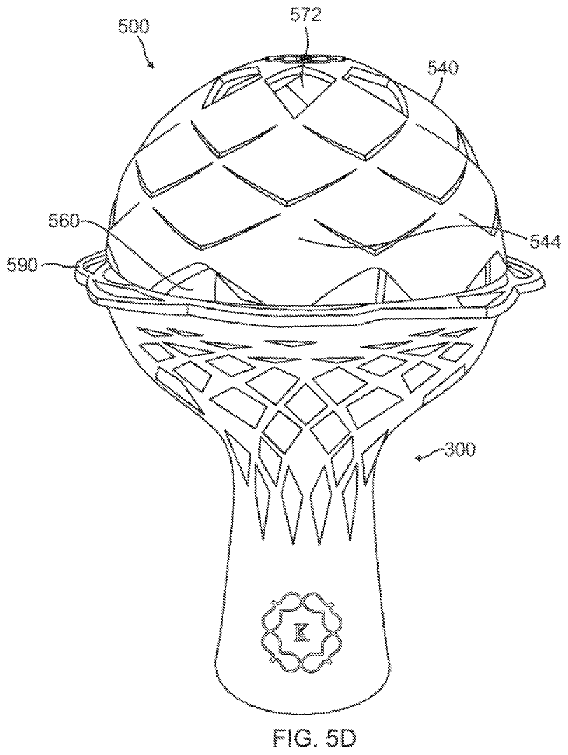

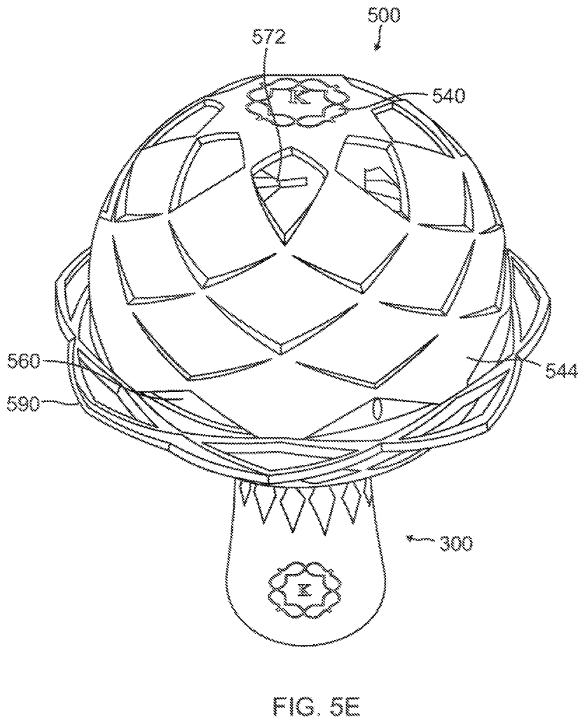

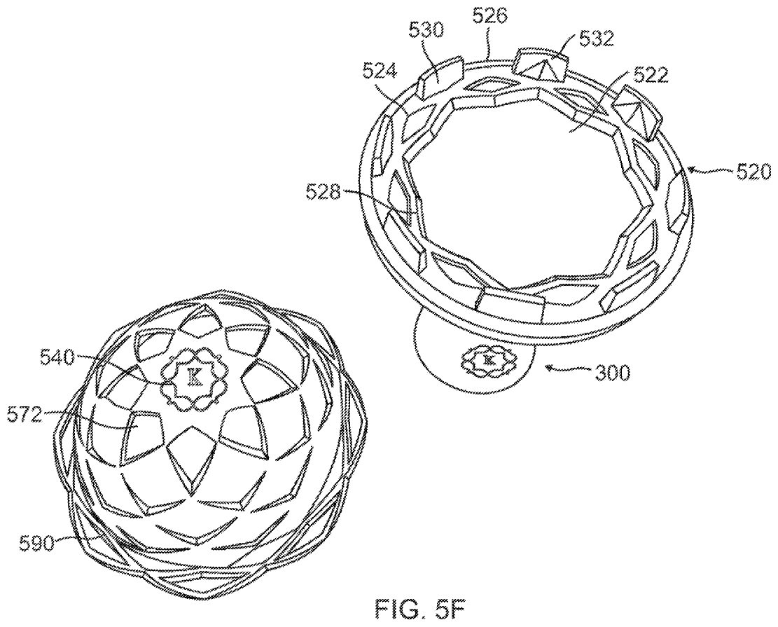

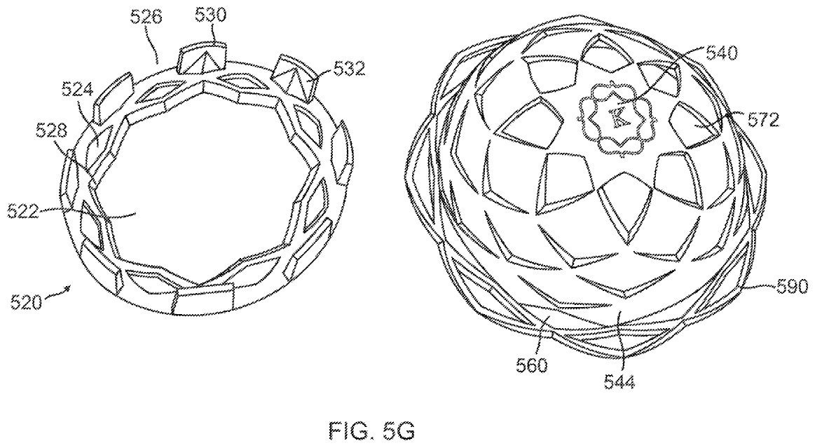

As shown in FIGS. 3A-3C, 5A-5B and 5F-5G, the platform 520 preferably comprises a recessed tray 522 for containing the heating source. The platform 520 also preferably comprises a plurality of perimeter bowl vents 524 for permitting airflow between the heating chamber and the bowl while in operation. As shown, eight perimeter bowl vents 524 may be used although other numbers of perimeter bowl vents 524 are also contemplated. The platform 520 also preferably comprises a plurality of perimeter vertical protrusions 530 that mate with corresponding protrusions 544 of the cap 540 to form circumferential vents 526 for controlling the airflow between the exterior atmosphere and the heating chamber. In various embodiments this mating may occur using screws and threading.

As the cap 540 is rotated relative to the platform 522, for instance by rotating cap 540 using rim 590 of FIG. 4, the respective protrusions 530 and spaces therebetween (i.e. the formed circumferential vents 526) may transition between fully open, partially open and fully closed with respect to adjustable side vents 560. In this manner, airflow to a heating chamber (e.g. 570 of FIG. 4E) may be controlled. In some embodiments, the cap 540 may further comprise additional upper vents 572, which may or may not be adjustable in different embodiments.

Platform 520 may be comprised of forged aluminum or steel. Similarly, cap 540 may be comprised of forged aluminum or steel.

Recessed tray 522 may include walls 528 which are flared inward from their upper edges. Walls 528 may prevent coals or other heating elements from sliding or otherwise moving around within heating chamber 570 during adjustment by users. The inward, downward flare of walls 528 may further promote airflow within heating chamber 570 by channeling air toward the heating elements. In the example embodiment, recessed tray 522 has a star configuration with eight points. Other embodiments may incorporate other shapes without departing from the scope of the invention. It has been discovered, however that the eight-pointed star configuration provides benefits over other shapes, including benefits of even heating and air flow, particularly when combined with the multi-chambered bowl described herein.

Circumferential vents 526 may comprise alternating spaces between vertical protrusions 530. The inner surface 532 of each vertical protrusion 530 may create a substantially “V” shape with the point directed inward, toward the center of heating chamber 570 from the circumferential vents 526 on either side of the vertical protrusion. Accordingly, air may be channeled toward heating elements on recessed tray 522. Additionally, the point of each “V” may correspond with each star point of recessed tray 522. It has been discovered that embodiments utilizing such an arrangement benefit from the created air channels which may promote circulation within heating chamber 570 and promote even heating of the coals or other heating elements during use.

Vertical protrusions 530 may be 1 mm to 100 mm in height. Circumferential vents 526 may be 1 mm to 100 mm in width and 1 mm to 100 mm in length.

Perimeter bowl vents 524 may be diamond, or other, shaped holes allowing airflow from the interior of heating chamber 570 into bowl 300. Each perimeter bowl vent 524 is preferably located near, such as directly in front of, a circumferential vent 526. This may promote a mixture of cool air from the exterior of the cap 540 with heated air from the interior of heating chamber 570 such that during inhalation by a user, heated air is not exclusively the only air being pulled through the water pipe. The location of perimeter bowl vents 524 as radially aligned with and proximate each circumferential vent 526 further promotes air flow, as discussed herein with respect to FIG. 5A. Perimeter bowl vents 524 may have dimensions of 1 mm to 100 mm in width and 1 mm to 100 mm in length.

Rim 590 may be an outward extension of cap 540 from a central axis perpendicular to heating platform 520 that allows users to rotate cap 540 with respect to platform 520. This may allow for different configurations of adjustable side vents 560 with respect to circumferential vents 526, allowing a user to control air flows into and out of heating chamber 570. Rim 590 is shown as a series of pointed extensions, attaching to cap 540 at protrusions 544 in FIG. 4. In some embodiments, rim may be insulated such that it may be handled by hand. Although rim 590 is shown as circumferentially surrounding cap 540 in FIGS. 4 and 5, it should be understood that it may only protrude outward in a single location, in a plurality of locations, or in partial circumferential areas.

In accordance with the embodiments described above and shown in FIGS. 4 and 5, a user can place or otherwise couple a platform 522 on or with a rim of a bowl 300 and thus, above tobacco, shisha or other organic matter already prepared as described above. Then a user can place coals or other combustible material on platform 522. Once the coals or other combustible material are in place, they can be heated by a heat source, for example a match or lighter, before a user places or otherwise couples a ventilated cap 540 on platform 522.

Turning to FIG. 5A, a cross sectional view of the exemplary ventilated cover 500 and head 300 including airflows 602, 604 is shown in accordance with at least one embodiment of the present invention. In the example embodiment airflow 602 represents at least one way in which air may move through heating chamber 570 when the device has coals (not shown) on platform 522 but air is not actively being pulled or otherwise inhaled through the water pipe. To elaborate, warm air within heating chamber 570 may rise through upper vents 572. Cooler air may enter heating chamber 570 through adjustable side vents 560 (here since multiple air flows 602 and 604 are shown, represented by adjustable side vent 560a) and then circumferential vents 526 to be heated by coals on platform 522. Thus air flow 602 during idle air times (e.g. non-active air pull or inhalation) is created.

Airflow 604 including 604a and 604b shows the flow of air when an active air pulling or inhalation through the water pipe occurs and the combination airflow 604c shows airflow through head 300 and into the lower components of the water pipe. Here, when a user is actively pulling air or inhaling through the water pipe, air may enter cap 540 into heating chamber 570 through upper vents 572 as flow 604b. Likewise, air may enter cap 540 into heating chamber 570 through adjustable side vent 560b and circumferential vent 526. Thus, the air passes heated coals on platform 522 and is pulled through perimeter bowl vents 524. At such point, it enters a space 318 between cover 522 and tobacco or other organic matter 308 to be smoked. In this space, the air may pick up smoke particles emanating from the heating of organic matter 308 by coals on platform 522 and combine into a single flow 604c through hollow tube 312.

FIG. 5B shows a cross sectional view of an example embodiment of ventilated cover 500 and head 300 in accordance with at least one embodiment of the present invention. In the example embodiment platform 522 is shown resting and nested in a complementary shaped rim portion 310 while cap 540 may rest on platform 522. As discussed elsewhere herein, one or both of these resting positions can include coupling mechanisms.

FIG. 5C shows a side view of an example embodiment of ventilated cover 500 and head 300 in accordance with the invention. FIGS. 5D-5E show an assembly of a head 300, with coupled platform 522 and cap 540. FIG. 5F shows a side view of the exemplary coupled ventilated cover platform 522 and head 300 with decoupled ventilated cover cap 540 in accordance with at least one embodiment of the invention. FIG. 5G shows a perspective view of an example embodiment of a decoupled ventilated cover cap 540 and platform 522 in accordance with at the invention.

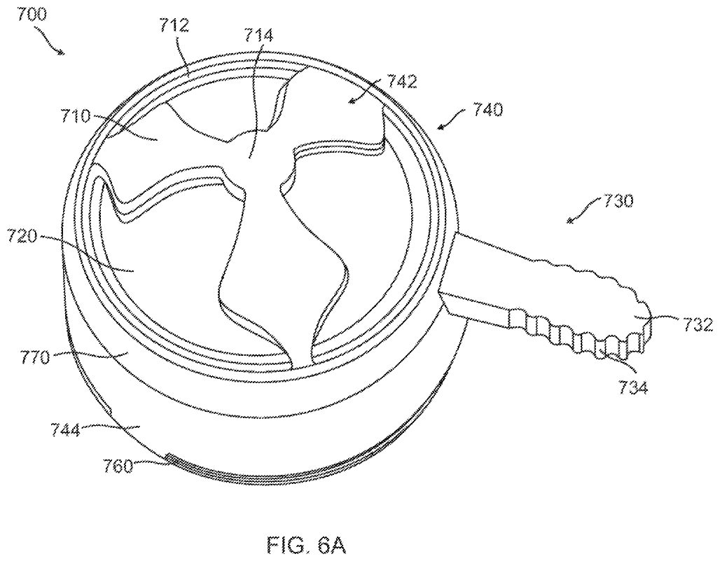

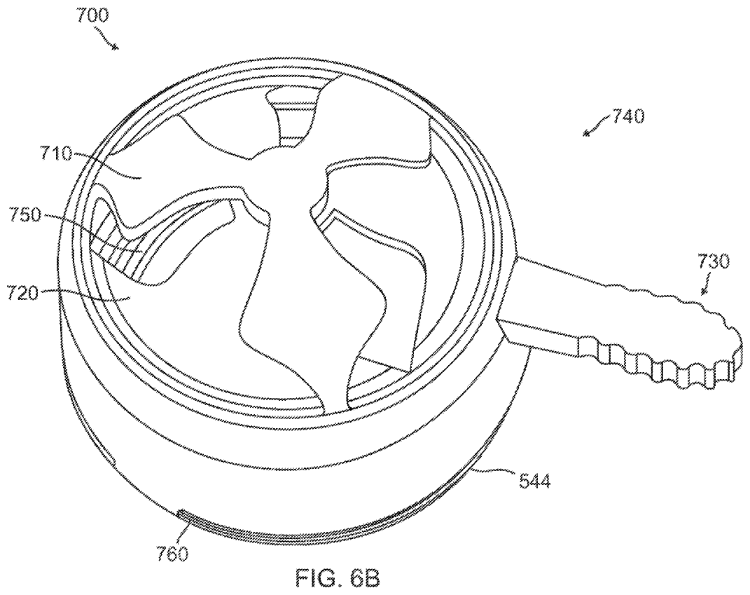

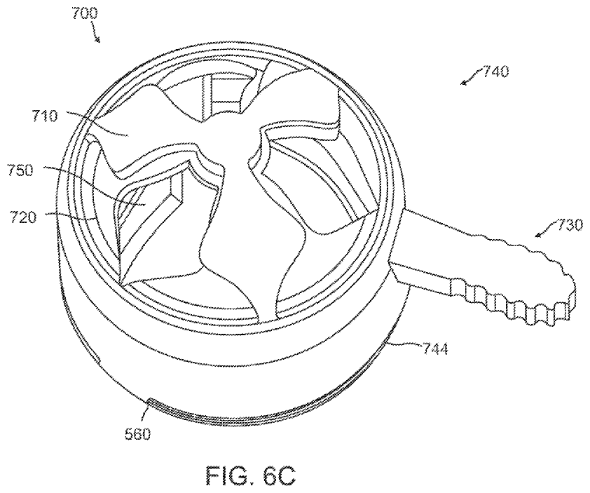

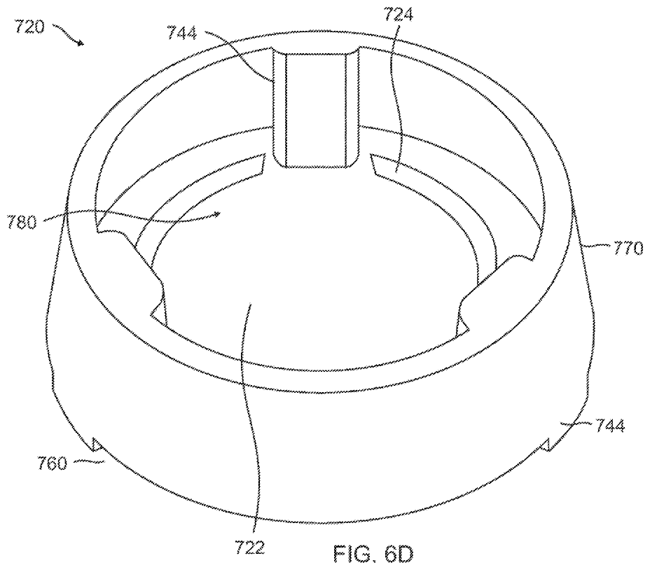

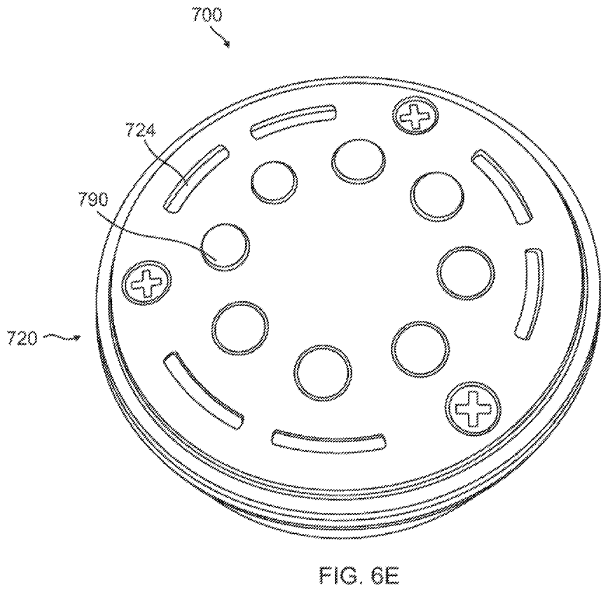

FIG. 6A shows a top view of a ventilated cover 700 with closed cover vents 750 in accordance with at least one alternative embodiment of the present invention. In the example embodiment a chamber wall 770 may include protrusions 744 that may mate with corresponding locations on platform 800 (shown in FIGS. 6D-6E), for instance with screws. These protrusions 744 may be separated from each other by gaps 760.

Cap 740 may have a handle 730 which may be coupled or integrated with cap 740. Handle 730 may include an insulated covering 732 which may have grip portions 734 such as ridges, bumps or other protrusions or features. Cap 740 may have an upper cap 742 as a wheel 712, hub 714 and spokes 710. In the example embodiment spokes 710 may have a substantially diamond shape. This may correspond with an upper vent 750 in a lower cap 720 such that in a closed configuration as shown in FIG. 6A, little airflow is permitted between an interior chamber and exterior. Upper cap 742 and lower cap 720 may be coupled at hub 714 such that they may rotate with respect to each other for adjustment of airflow. Coupling may be achieved by a screw and washer or other means. Lower cap may be maintained in position by one or more posts which extend into a heating chamber 780 and contact an inner wall of chamber wall 770. Posts may also contact upper ends of protrusions 744 in some embodiments to prevent rotation of lower cap 720 at the same rate as upper cap 742.

FIG. 6B shows a top view of a ventilated cover 700 with partially closed upper vents 750 in accordance with at least one embodiment of the present invention while FIG. 6C shows a top view of a ventilated cover 700 with open cover vents 750 in accordance with at least one embodiment of the present invention. Cover vents 750 may be adjusted by a user rotating upper cap 742 with respect to lower cap 720 using handle 730.

FIG. 6D shows a top view of a ventilated cover with cap 740 removed in accordance with at least one embodiment of the present invention. In the example embodiment platform 722 may include a surface where a heating source may rest and perimeter bowl vents 724 may allow air exchange from a heating chamber to a bowl (not shown) below platform 722. Chamber wall 770 may have an upper surface 772 on which a lower surface of one or both of upper cap 742 and lower cap 720 rest. In some embodiments ridges or other regular or irregular features may allow airflow below a heating source and improve airflow with the chamber.

FIG. 6E shows a bottom view of a ventilated cover 700 in accordance with at least one embodiment of the present invention. In the example embodiment platform 722 may have small nodules 790 which rest inside a bowl. In some embodiments these nodules 790 may direct heat into individual chambers of the bowl. Nodules 790 may also prevent ventilated cover 700 from inadvertently sliding or being knocked off of a head (not shown) since they may rest inside a bowl of a head.

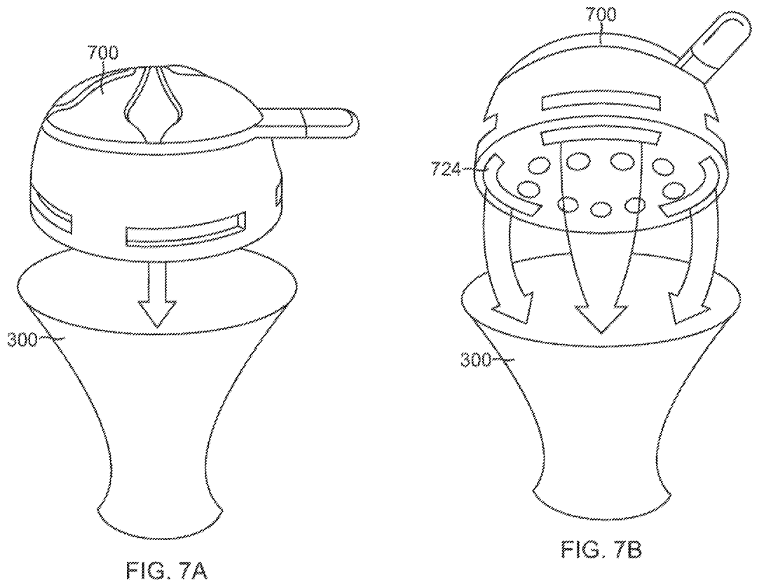

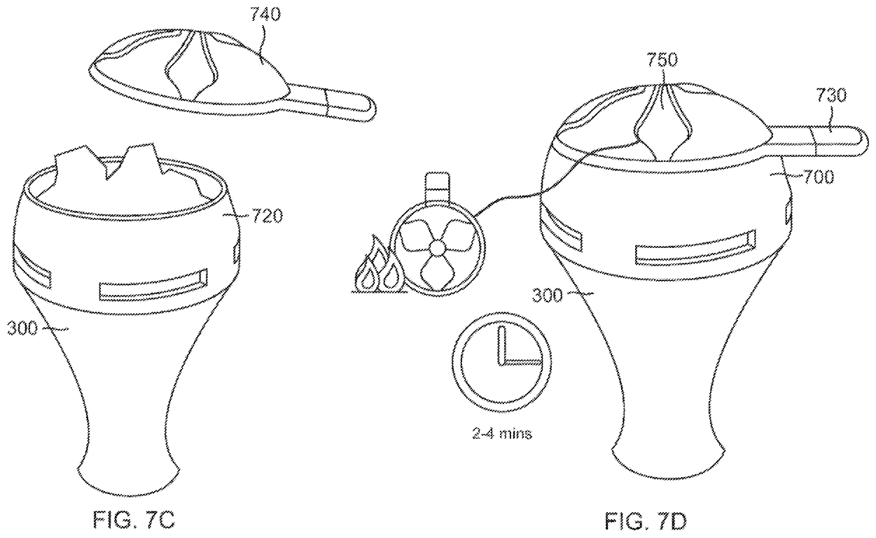

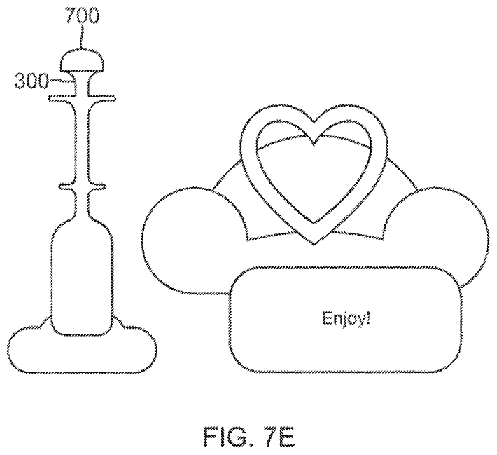

FIG. 7A-7E show a use case of a ventilated cover 700 in accordance with at least one embodiment of the present invention. In an example embodiment a ventilated cover 700 as disclosed herein may be placed on a water pipe head 300 as shown in FIG. 7A, such that at least one perimeter bowl vent (not shown) is oriented above the head 300, as shown in FIG. 7B. A heating source may be added within a heating chamber on a platform inside ventilated cover 700, as shown in FIG. 7C. This may be lit with a flame or otherwise heated such that the heating source produces heat. Vents may be closed to warm up the chamber and then the vents may be opened to an appropriate amount by rotating using arm or other adjustment mechanism in order to allow adequate ventilation. Users can wait two to four minutes or other appropriate lengths of time in order for tobacco or other organic matter to be appropriately heated, as shown in FIG. 7D. Air can be drawn through the heated tobacco or shisha contained in bowl 300 by a user inhaling through an adequately coupled hose and smoked and enjoyed accordingly, as shown in FIG. 7E.

In general, a ventilated cover 700 and bowl 300 may be washed by hand for optimal cleaning using hot water and soap or other appropriate cleaner. Likewise, a ventilated cover may be handled with tongs to ensure a user does contact surfaces which may be hot with the exception of handles or rims to adjust vents. When vents are open or a cap is removed, a ventilated cover 700 will generally be at its coolest temperature. When vents are closed, ventilated cover 700 may be at its hottest temperature. As such, bowl 300 will likewise be at a coolest and hottest temperature in accordance with these principles.

As would be understood by one in the art, features described herein and shown in the figures may be combined in appropriate combinations and are thus contemplated herein. Further, although FIG. 7 particularly illustrates a use case of the example embodiment ventilated cover 700 shown in FIG. 6, it is understood that one of skill in the art would understand how to use any combination of features as described with respect to the embodiments disclosed herein, including other ventilated covers and bowls. Further, as would be understood in the art, the shapes disclosed herein are not limiting. For instance, a round bowl could be replaced by a triangular or square bowl in various embodiments, as could diamond shapes be replaced by others.

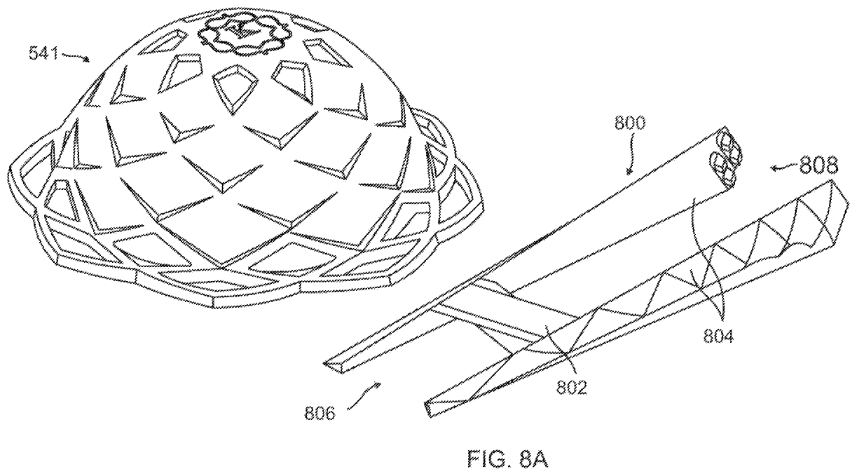

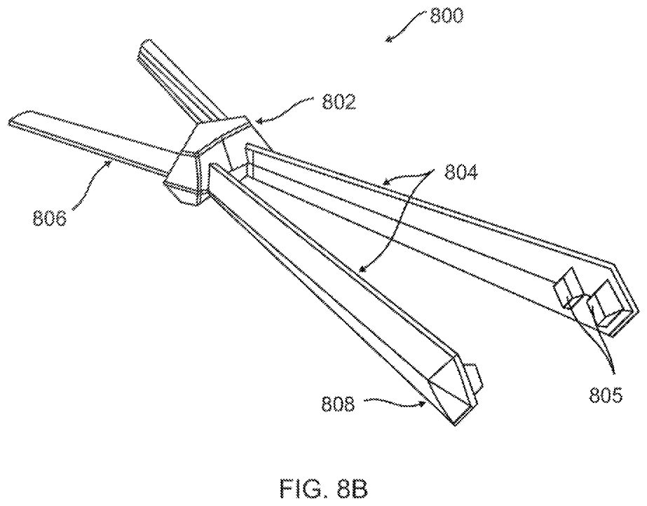

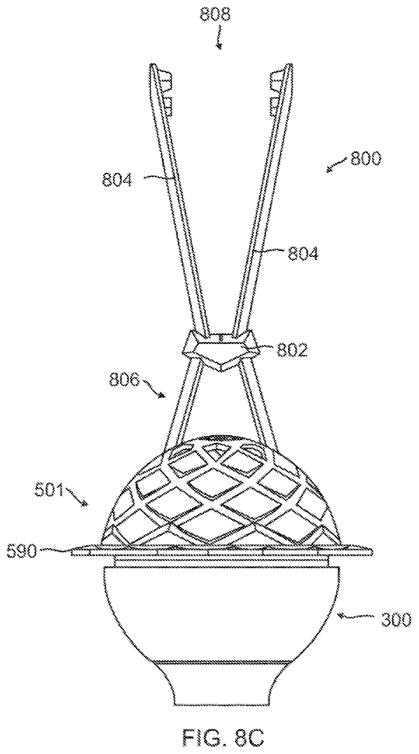

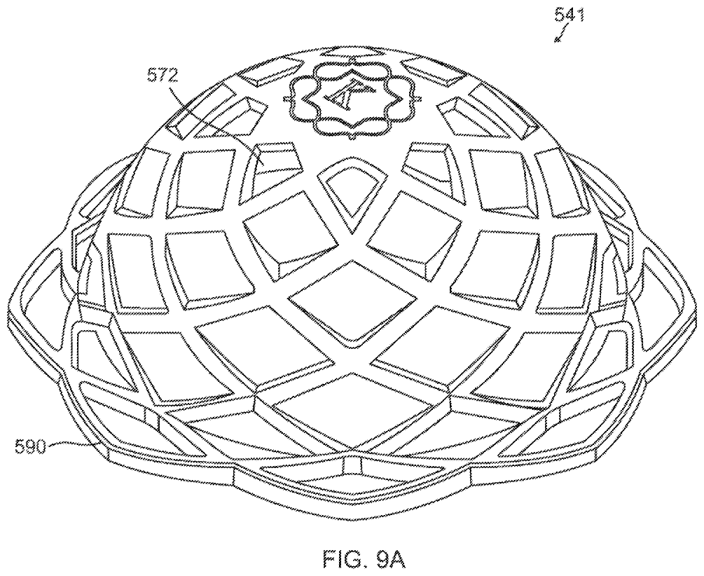

FIG. 8A shows an example embodiment of a perspective view of a ventilated cover cap 541 and multi-functional tongs 800 in accordance with the present invention. In the example embodiment, tongs 800 can be used to adjust and remove various portions of a water pipe, including a ventilated cover cap 541.

FIG. 8B shows an example embodiment of a perspective view of multi-functional tongs 800 in accordance with the present invention. In the example embodiment, tongs 800 can include one, two, or more of legs 804 which can be made from a variety of materials, including stainless steel, silicone, wood, glass, or any combination thereof. Legs 804 can have a first end 806 which can interface with a lid. Legs 804 can have a second end 808 which can interface with charcoal or other heat source. As shown, second end 808 of tongs 800 can include one or more tong protrusions 805 to interface with charcoal or other heat sources. In some embodiments, tong protrusions 805 can provide insulation properties such that heat is not transferred directly to legs 804.

Legs 804 can be coupled at a hinge 802 which can be silicone, or some other flexible material, in various embodiments. Hinge 802 can provide users the ability to manipulate the first and second ends 806 and 808 in a simple and intuitive manner, without the possibility of dropping one leg 804. In this manner, legs 804 can be manipulated in a manner similar to chopsticks, but with additional functionality. In the example embodiment, legs 804 are shown as slightly bowed such that there is a gap between them at both first and second ends 806, 808.

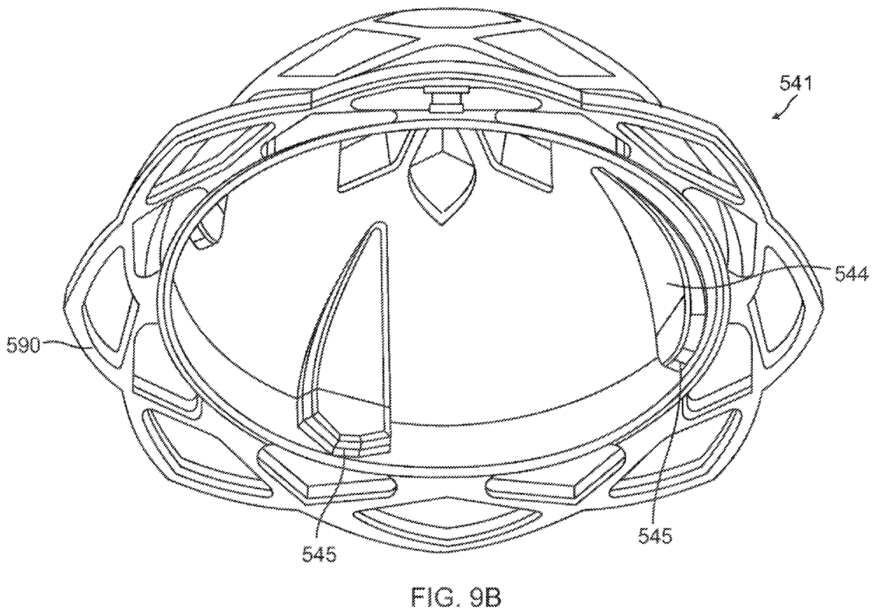

FIG. 8C shows an example embodiment of a side view of a ventilated cover 501 and coupled bowl 300 with multi-functional tongs 800 in a use case in accordance with the present invention. In the example embodiment tongs 800 are shown as coupled with ventilated cover 501 for manipulation with respect to bowl 300. Tongs 800 can also be coupled with elements 524, 560, 572, and 590. Thus, tongs 800 can be used to rotate, lift, and otherwise adjust ventilated cover 501. In the example embodiment, first end 806 of legs 804 can be shaped similarly in a complementary fashion to an interface surface of upper holes (e.g. 572 of FIG. 9A) of a ventilated cover 501. In this manner tongs 800 can be used to easily adjust ventilated cover 501. Although not shown, additional components and features of first end 806 can be provided in various embodiments of tongs 800 such as varied surfaces, materials, protrusions, projections and others in order to improve grip and promote convenient and intuitive usage for users. First end 806 of tongs 800 are not limited for use with upper holes of a ventilated cover 501 as shown. They can also be used to grasp, grip or otherwise adjust ventilated cover 501 at various other locations, for instance at rim 590 and at openings 524 and 560.

FIG. 9A shows an example embodiment of a top perspective view of a ventilated cover cap 541 in accordance with the present invention. In the example embodiment, the upper surface and features of cap 541 can be similar to that shown in FIGS. 4A-4D.

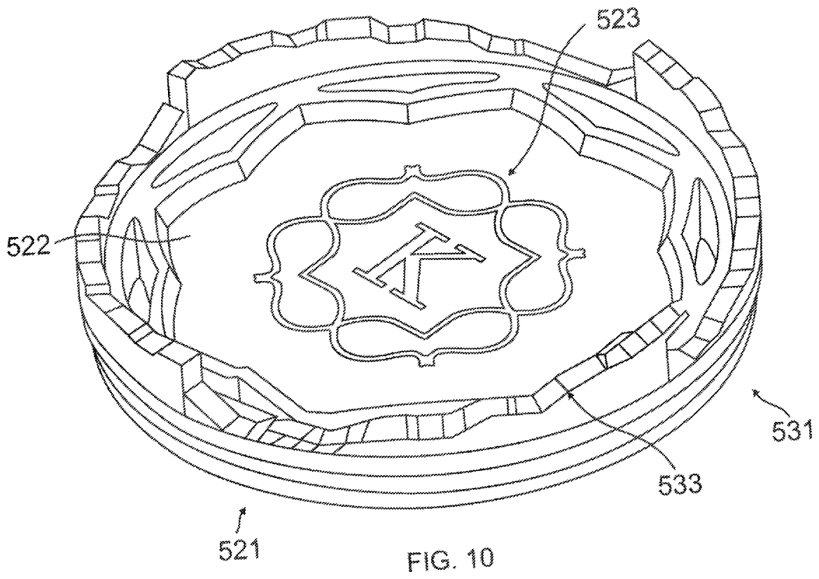

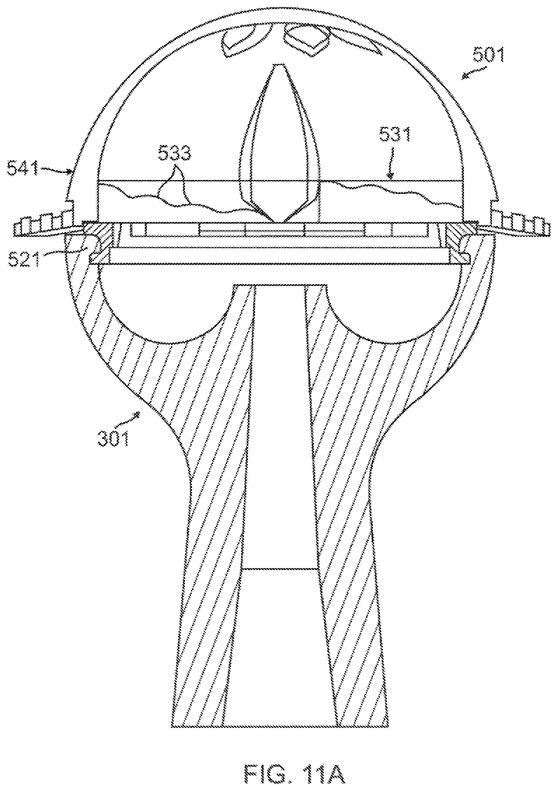

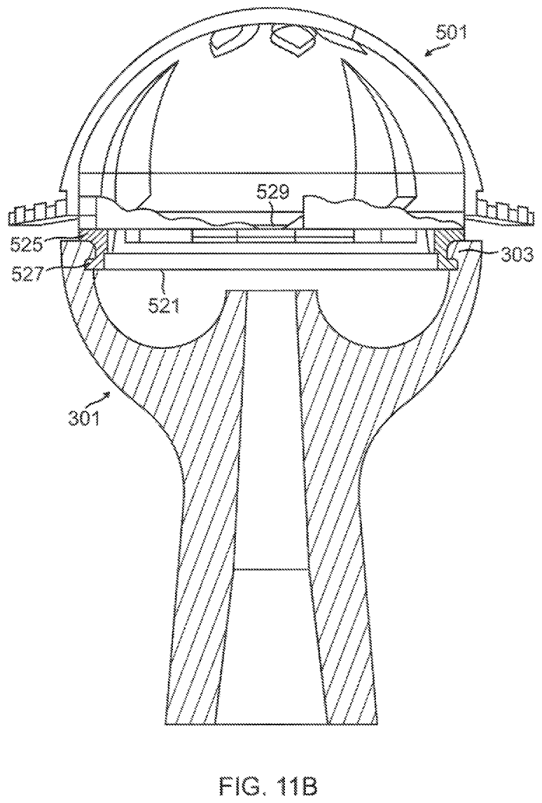

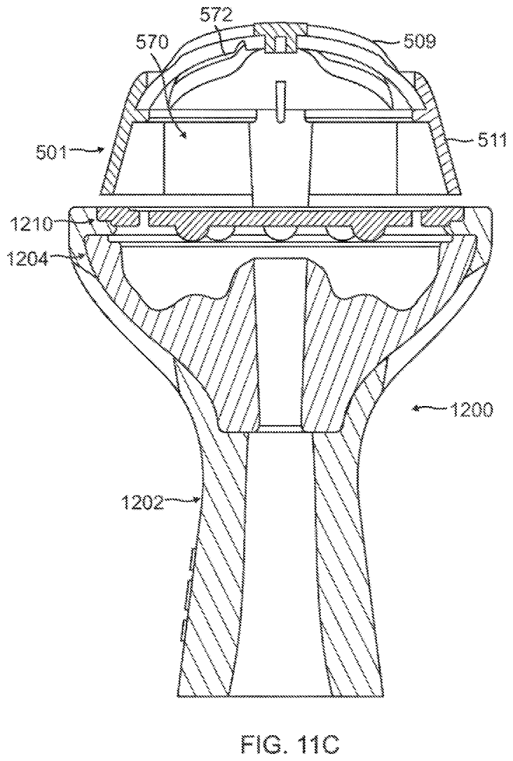

FIG. 9B shows an example embodiment of a bottom perspective view of a ventilated cover cap 541 in accordance with the present invention. In the example embodiment, teeth 545 can be provided at a lower surface of protrusions 544. Teeth 545 can be locked or otherwise interface with a platform (e.g. 521 of FIG. 10) as shown in FIGS. 11A-11B. This can provide various benefits, including a secure interface with other components such that if a water pipe with ventilated cover cap 541 is knocked over, charcoal or other heat sources will be substantially contained and not fall on a floor, table or other supporting surface. This can help mitigate danger of burns, injury, scars and other damage associated with using heat sources. While four teeth 545 are provided in the example embodiment, other embodiments may include additional or fewer teeth 545.

FIG. 10 shows an example embodiment of a top perspective view of a ventilated cover platform 521 in accordance with the present invention. In the example embodiment, a raised surface 523 can provide a slight elevation over a normal tray (not shown) or recessed tray 522 for charcoal or other heating elements. As such, heat emanating from the bottom of a heat source can be more evenly distributed across upper tray surfaces. Additionally, a ramp 531 with detents 533 can be provided in order to allow for more precise control of circumferential vents (see element 529 of FIG. 11B, similar to 526 of FIG. 5A). Ramp 531 with detents 533 can provide circumferential vent sizing in both a vertical and horizontal direction and thus the width and height of circumferential vents can be precisely controlled by placement at or on particular detents in order to increase or decrease airflow inside a ventilated cover cap 541. In some embodiments, teeth 545 provide the interface with ramp 531 and in some embodiments can be shaped to rest in detents 533.

FIG. 11A shows a side cutaway view of an example embodiment of a rotating lid 501 including coupled ventilated cover cap 541, platform 521 and head 301 in a closed configuration in accordance with the present invention. In the example embodiment, the rotating lid 501 is in a closed configuration, meaning that circumferential vents are sealed.

FIG. 11B shows a side cutaway view of an example embodiment of a rotating lid 501 including coupled ventilated cover cap 541, platform 521 and head 301 in an open configuration in accordance with the present invention. In the example embodiment, a user has rotated cap 541 with respect to platform 521, thus causing circumferential vents 529 to open and allow airflow into cap 541. Also shown are an interlock between a ridge 303 of base 301 and lower lip 529 and upper lip 525 of platform 521 to provide a seal, which in some embodiments is airtight, between rotating lid 501 and bowl 301. As such, lid 501 will not fall off of bowl 301 if adjusted or accidentally knocked over by a user or third party.

FIG. 11C shows another example embodiment of a ventilated cap 501 coupled to a bowl 1200. In the example embodiment, ventilated cap 501 includes a chamber 511 with an adjustable upper component 509 allowing for separate adjustment of upper vents 572 with respect to heating chamber 570.

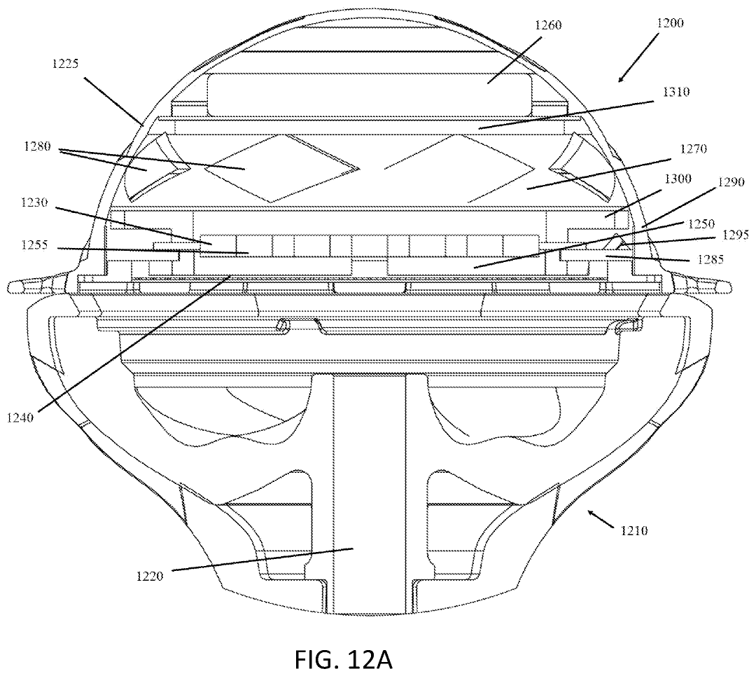

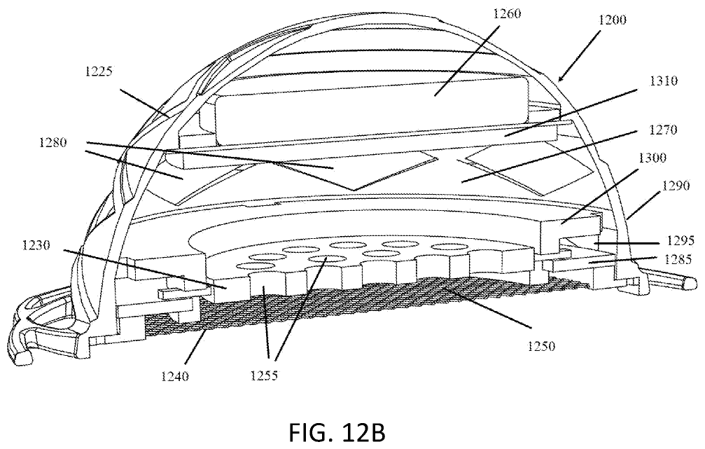

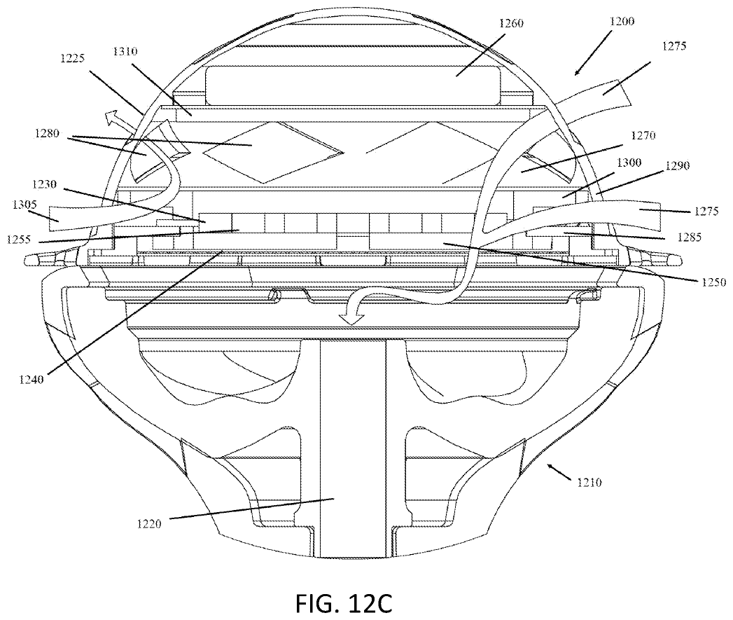

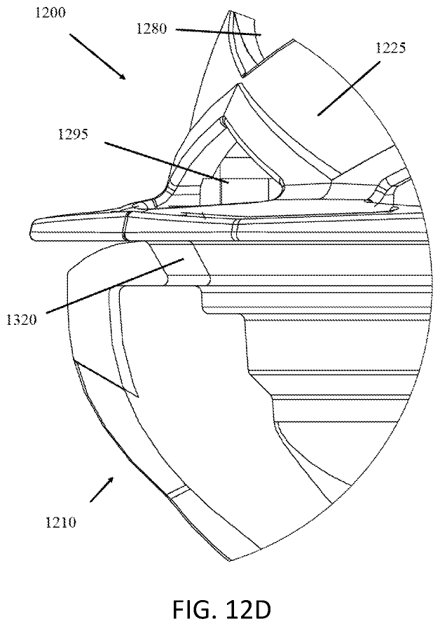

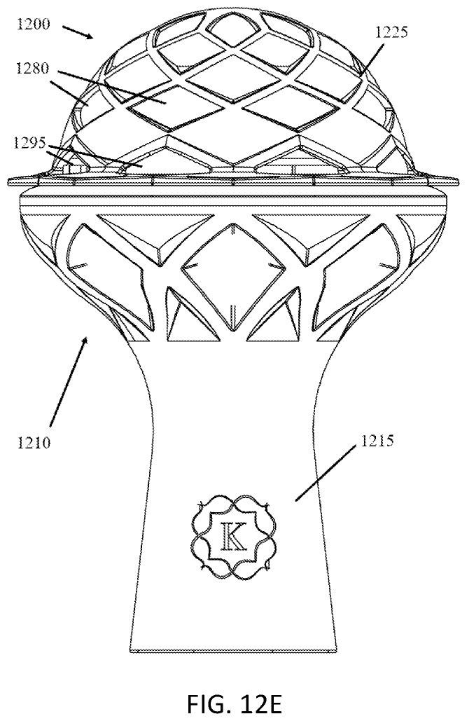

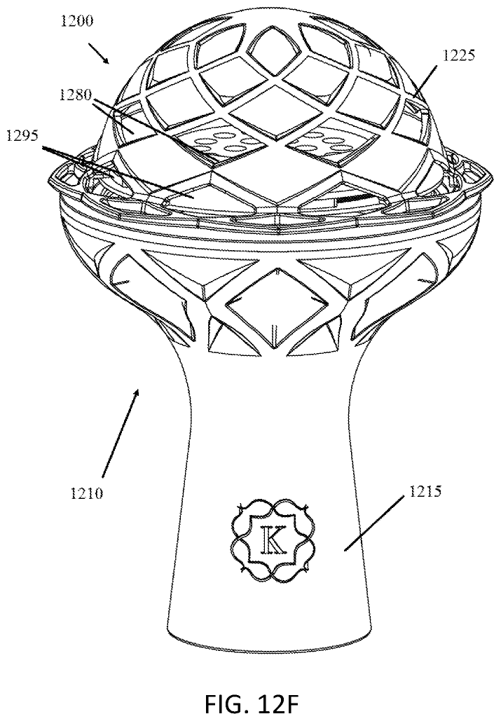

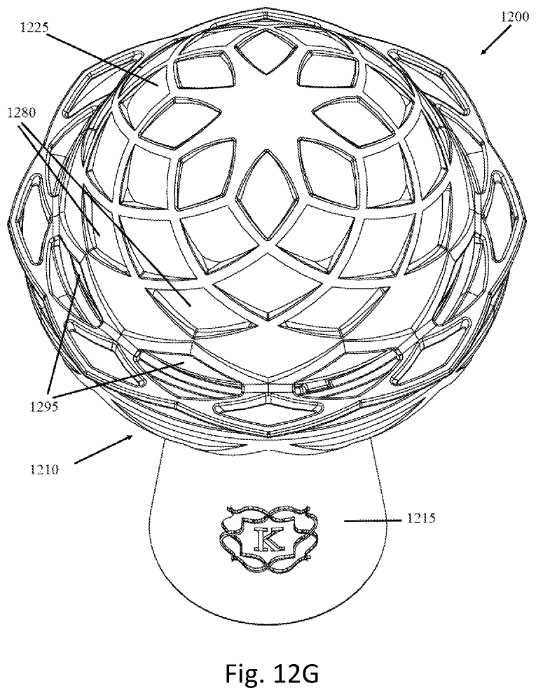

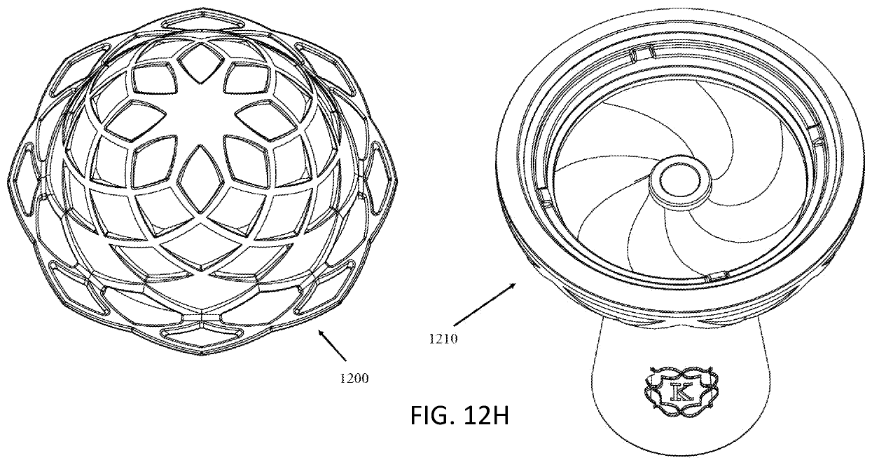

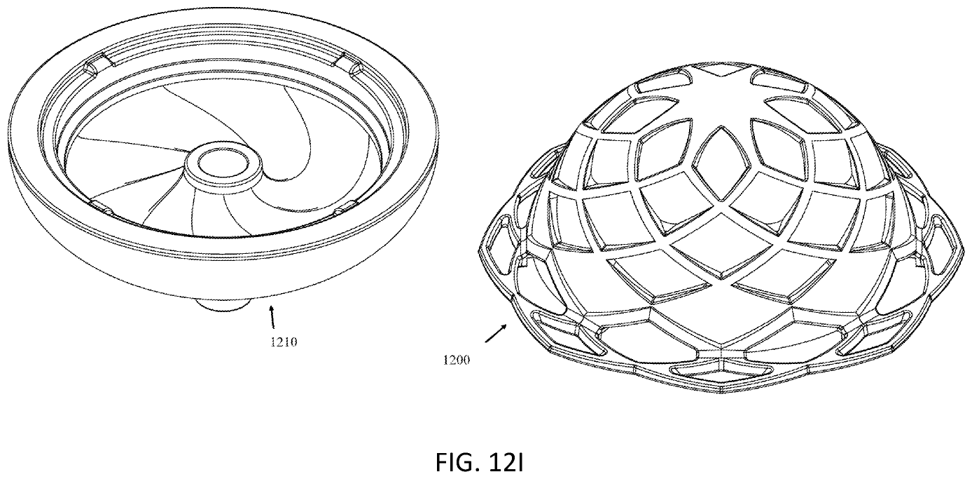

FIGS. 12A-12I illustrate an example embodiment of an electric heating head for use in the heat management accessory disclosed herein. FIG. 12A shows a sectioned view of electric heating head and FIG. 12B shows a sectioned perspective view of the same. FIG. 12C shows an example of airflow through the electric heating head provided.

As shown in FIG. 12A, an electric heating head 1200 is provided for resting on a bowl 1210. The bowl head 1210 may be similar to the bowl 300 discussed above with respect to FIG. 2. Accordingly, in the embodiment shown, located central to the bowl 1210, and forming a portion of the inner surface of the bowl, may be a hollow tube 1220 extending the length of the bowl 1210 from the bowl head through a bowl stalk 1215. As discussed above, the bowl is typically operable to contain tobacco or other smokable substances.

The heating head 1200 comprises a housing 1225 containing a heating element 1230, a screen 1240 located between the heating element 1230 and the bowl 1210 when the heating head 1200 is rested on the bowl, and a lower air gap 1250 between the heating element 1230 and the screen 1240. The screen 1240 is made of a material, such as mesh or wire, having openings finer than the smokable organic substance, so that the smokable organic substance cannot pass through the screen 1240.

The housing 1225 would typically further contain a battery 1260 and an upper air gap 1270 between the battery and the heating element 1230. The housing would further have at least one vent 1280 for allowing outside air to enter the housing 1225.

The heating element 1230 is typically a heated plate having perforations 1255, such that airflow heated in the upper air gap 1270 of the heating head 1200 may be drawn through the heated plate and into the bowl 1210. The perforations 1255 in the heated plate 1230 are openings large enough for air to easily pass through the heating element 1230 and thereby pass from the upper air gap 1270 to the lower air gap 1250. Typically, the perforations 1255 in the heated plate 1230 are larger than any openings in the screen 1240, such that the screen prevents any smokable materials from entering the heating head 1200. The heating element 1230 is typically made of ceramic, or any other material generally used for heating elements.

Accordingly, the heating head 1200 typically comprises a heating element 1230 sandwiched between a battery 1260 located above and a screen 1240 located below, with an upper air gap separating the battery from the heating element and a lower air gap separating the screen from the heating element. The ventilated housing 1225 then exposes the upper air gap to environmental air.

As shown in FIG. 12C, during use, a user would draw air through the hollow tube 1220. Upon doing so, outside air would be drawn through the vents 1280 in the housing 1225 and enter the upper air gap 1270. Air would then be drawn through the perforations 1255 in the heating element 1230 and into the lower air gap 1250. While passing through the perforations 1255, the air would heat. The heated air would then pass through the screen 1240 and heat the smokable materials in the bowl 1210. As shown, the vents 1280 may be eight vents, or may be any other number of vents provided in a pattern to improve the overall aesthetics of the heating head 1200.

As the user continues to draw air through the hollow tube 1220, smoke generated by the smokable material, now heated by the heated air, would be drawn into the hollow tube, along with the air. Such air would then be displaced by newly heated air which continues to heat the smokable material. This is shown in FIG. 12C as airflow 1275.

In some embodiments, a printed circuit board (PCB) 1285 is provided to control the temperature of the heating element 1230, as well as other controllable aspects of the functioning of the heating head 1200. The PCB 1285 may be provided as a circular circuit board provided adjacent an outer wall 1290 of the heating head 1200. In such an embodiment, the heating element 1230 may be centered in the heating head, as shown, such that the PCB 1285 encircles the heating element. Additional electrical components, not shown, may be provided. For example, various sensor configurations may be provided to track the temperature of the heating element and battery remaining. The PCB 1285 may then function to implement control schemes selected by the user.

Where the PCB 1285 is located adjacent the outer wall 1290 of the heating head 1200, a heat shield 1300 may be provided to insulate the PCB from the heat generated by the heating element 1230. As shown, the heat shield 1300, which may be silicon, for example, may encircle the heating element 1230. In order to cool the PCB 1285, additional vents 1295 may be provided in the outer wall 1290 adjacent the PCB, such that the PCB is exposed to outside air while being insulated from air inside the heating head 1200. In some embodiments, the additional vents 1295 may be similar in number to the vents 1280 providing air to the upper air gap 1270. Accordingly, as shown, eight additional vents 1295 may be provided to cool the PCB 1285.

Further, the PCB 1285 may not be fully sealed by the heat shield 1300, and air may pass between the segment of the housing containing the PCB and the upper air gap 1270 and lower air gap 1250. Accordingly, air entering the housing 1225 by way of the additional vents 1295 may enter the upper air gap 1270 and exit the housing, as shown by airflow 1305, or it may enter the lower air gap 1250 as shown by airflow 1275.

In this way, by providing cool airflow that entered through additional vents 1295 to mix with the hot airflow that passes through the heating element 1230, a user may draw cool air into the hollow tube 1220 that then mixes with the smoke from the smokable material in the bowl 1210. Further, the various airflow paths 1275, 1305 may be followed by air during different times and in different use conditions. For example, the airflow path 1275 typically illustrates airflow during a time when a user is actively drawing air into the hollow tube 1220, while airflow path 1305 may represent airflow when the heating head 1200 is otherwise idle and no air is being actively pulled into the hollow tube 1220.

Similar to the heat shield 1300 protecting the PCB 1285, the battery 1260 may be provided with a heat shield 1310 thereby insulating the battery 1260 from the interior space and upper air gap 1270 of the heating head 1200. Accordingly, while the battery is separated from the heating element 1230 by the upper air gap 1270, and the airflow shown in FIG. 12C typically constantly replaces the air in the heating head with cool air drawn through the vents, 1280, the air inside the heating head may still become hot, thereby damaging or lowering the efficiency of the battery 1260. For this reason, the heat shield 1310 may provide additional protection for the battery 1260.

In addition to the heat shield 1310, the battery 1260 is adjacent an upper surface of the heating head 1200, and that upper surface is exposed to outside air flow, and therefore may remain cooler than the interior upper air gap 1270 of the heating head. Further, in some embodiments additional ventilation (not shown) may be provided to cool the battery 1260.

The ventilated housing 1225 may be made of any number of materials. For example, it may be formed from forged aluminum or steel.

In some embodiments, nodules (not shown) may be provided on a bottom surface of the screen 1230. Such nodules may direct heat towards different portions, or different compartments, of the bowl 1210.

FIG. 12D provides a cross sectional view of an example embodiment of heating head 1200 mated with the bowl 1210 in accordance with at least one embodiment of the present invention. As shown, the heating head 1200 rests on and nests in a complementary shaped rim portion 1320. As discussed elsewhere herein, the rim portion 1320 and the bottom of the heating head may be provided with a coupling mechanism. In some embodiments, ridges may be provided in the heating head 1200 for coupling with the bowl 1210. Accordingly, the heating head 1200 may be fixedly coupled with the bowl 1210 when resting on the bowl.

FIG. 12E shows a side view of an example embodiment of heating head 1200 mounted on a bowl 1210 in accordance with the invention. FIGS. 12F-12G show perspective views of the heating head 1200 mounted on the bowl 1210 as shown in FIG. 12E. FIGS. 12H-12I show perspective views of the heating head 1200 decoupled from the bowl 1210 in accordance with at least one embodiment of the invention.

The embodiments described in detail above are considered novel over the prior art of record and are considered critical to the operation of at least one aspect of the invention and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element may be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what may be obviously substituted, and also what incorporates the essential ideas.

The scope of this description is to be interpreted only in conjunction with the appended claims and it is made clear, here, that the named inventor believes that the claimed subject matter is what is intended to be patented.

What is claimed is:

1. A heating head for resting on a bowl operable to contain tobacco or other smokable substances, the heating head comprising:
a heating element;
a screen located between the heating element and the bowl when the heating head is rested on the bowl; and
a lower air gap between the heating element and the screen,
wherein the screen is finer than the smokable organic substance, so that the smokable organic substance does not pass through the screen.

2. The heating head of claim 1, wherein the heating head includes ridges for coupling with the bowl.

3. The heating head of claim 1, wherein the heating head includes nodules on a bottom surface of the screen.

4. The heating head of claim 1, wherein the heating head can be fixedly coupled with the bowl when resting on the bowl.

5. The heating head of claim 1, wherein the heating element is perforated such that air passes through the heating element and through the screen into the bowl.

6. The heating head of claim 1, wherein a printed circuit board (PCB) is located adjacent an outer wall of the heating head, and wherein the heating element is centered in the heating head.

7. The heating head of claim 6, further comprising a heat shield insulating the PCB from the heating element.

8. The heating head of claim 7, wherein the heating element is perforated such that an only path between an interior of the heating head and the bowl is through the heating element.

9. The heating head of claim 7 further comprising at least one PCB vent provided in the outside wall for cooling the PCB.

10. The heating head of claim 1 further comprising:
a ventilated housing, and
a battery, and
wherein the heating element, screen, and battery are located within the housing.

11. The heating head of claim 10 further comprising at least one venting opening, and
wherein the battery is opposite the heating element from the screen, and
wherein an upper air gap is provided between the heating element and the battery, and
wherein the venting opening provides access from outside the housing into the upper air gap.

12. The heating head of claim 11, wherein the heating element is perforated, such that air passes through the venting opening into the upper air gap, is heated by the heating element, and passes through heating element into the lower air gap, and passes through the screen into the bowl.

13. The heating head of claim 12, wherein the perforations of the heating element are larger than any perforations in the screen.

14. The heating head of claim 10, further comprising a heat shield insulating the battery from the rest of the interior space.
